(19) United States
(12) Patent Application Publication
(10) Pub. No.: US 2016/0148199 A1
(43) Pub. Date: May 26, 2016

(54) Method for Calculating and Converting the Value of Currency During Financial Transactions Using an Account Backed with Precious Metals

(71) Applicant: Toomas VITSUT, Tallinn (EE)

(72) Inventor: Toomas Vitsut, Tallinn (EE)

(21) Appl. No.: 14/409,919

(22) PCT Filed: Aug. 8, 2014
(86) PCT No.: PCT/EE2014/000004

§ 371 Date: Dec. 19, 2014

(30) Foreign Application Priority Data
Aug. 12, 2013 (EE) U201300071

(51) Int. Cl. G06Q 20/38; G06Q 20/10

(52) U.S. Cl. CPC G06Q 20/381; G06Q 20/102

(57) ABSTRACT

A method for calculating and converting the value of currency during financial transactions using an account backed with precious metals using info-technological means and a computer system is a method compatible with banking system converting gold or precious metal kept on a special account into liquid assets. The account is 100% backed with intrinsic value of physical gold or physical precious metal by the bank or service provider. The account is backed by the intrinsic value of the precious metal. The gold on the backed account belongs to the owner of the account, but is held by the bank or the service provider both before it is purchased by the user and after the payments. Making all payments to the backed account as well as using the account to make payments is only performed in currency and through a digital valuator. When a payment is made to the backed account, the currency is converted into gold. When payments are made from the backed account, the gold is converted into currency (FIG. 3). The exchange rate of physical gold held in the account to any currency is not fixed (gold standard is not used). The value of the precious metal is formed by supply and demand on the markets. Converting gold into currency (and vice versa) is based on the market price of gold at the moment of payment. Conversion of gold into liquid assets is performed by a payment system that allows using the account backed with precious metal (gold) on equal basis with a currency account (currency and checks). The payment system allows to exchange gold or precious metal with goods and services on the same conditions as currency.

### FIELD OF TECHNOLOGY

The invention comprises a method for calculation and conversion during financial transactions in a payment system, where user accounts are backed with precious metals.

### STATE OF ART

State of art is established in document U.S. Pat. No. 5,671,364, James Turk, G06F 15/30, 1997 “Method and system for commodity-based currency for payment of accounts and elimination of payment risk”. In addition to said solution, other documents, such as U.S. Pat. No. 5,983,207 A, U.S. Pat. No. 6,415,271 B1, U.S. Pat. No. 7,206,763 B2 and US 2002/004779 A1 also search the answer to the question how to use assets with intrinsic value for creating means of payment parallel to currencies. People searching for a solution try to manage the risks arising from the instability of currencies. There have been repeated attempts to solve this problem by linking or fixing a currency's exchange rate to a fixed amount of gold (establishing a gold standard). One of the most influential solutions has been the Bretton Woods system (Benjamin J. Cohen, Bretton Woods System, www.polsci.ucsb.edu/faculty/cohen/inpress/bretton.html).

The solutions offered in these documents focus on using gold or precious metals as a means of payment supported by up-to-date info-technological means.

The purpose of the patent (U.S. Pat. No. 5,671,364) is to eliminate the risks related to exchange rate and significant loss of value of currencies by alternative use of gold or precious metals in for making payments. Companies refer to long payment deadlines as payment risks due to the constantly changing value of currencies. It is assumed that the value of gold or precious metals is more stable than the value of a national currency. The purpose of the method is to create a network that allows making payments in gold and precious metals, similar to currency payments.

However, this method (U.S. Pat. No. 5,671,364 B1) is not designed to function as a part of the modern banking system, but requires a separate network of users who accept such method. Payments between the users of the system are made via a computer system. The scope of using the payment system depends on the size of network or the number of users.

Even in case of a network comprising different states and cities (US 2010/299257 A1, James Turk, G06Q 40/00, 2010 “Method and system for commodity-based currency for payment of accounts”), its scope and potential cannot be compared with a global banking system or compete with it in terms of its scale. A system that is not compatible with already established banking system restricts its potential use for purchasing goods and services. The method allows using gold or precious metals for making payments between the members of the network, but does not allow using banking services directly. The method prescribes that gold or other assets of intrinsic value are used in the payment system on equal terms with currency and calculation is made in units of gold. In order to make payments a member of the network has to deposit a certain amount of physical gold or precious metal, the quantity and purity of which is evaluated. This option is made available in a limited number of secure cities such as London, New York, Zurich, and Tokyo. Only then, the system user can make payments to other members of the network. In consideration of all that, joining the system and using it becomes a long and inconvenient process. Any inconveniencies reduce the motivation to use the system. The method gives no consideration to those who wish to make small-scale payments, i.e. the threshold is too high for a wider customer base.

The method presented in the invention of James Turk follows the example of currency circulation in the banking system, but payments made with precious metals have no direct connection to the banking system, compromising liquidity of assets. Another disadvantage lies in the inconvenience of joining the network and depositing physical precious metal, as well as compulsory evaluation of purity. The complexity of using the method and the obligation to deposit physical precious metal restricts its use for users who wish to make small-scale payments.

### NATURE OF THE INVENTION

The purpose of the invention is to eliminate the disadvantages described above by proposing a method that can be used as a part of the banking system, makes the system easier to join and use precious metals for making payments as easy as using national currencies for paying for goods and services. The object of the method is to back the value of the financial asset deposited on currency account with intrinsic value of gold or another precious metal, and to make it liquid with the aid of the payment system.

The set task is solved by using a method for calculating and converting the value of currency during financial transactions on an account backed with precious metals by using info-technological means and a computer system to liquidize the precious metal according to which calculation of financial transactions is based on the units of weight of the precious metal acquired by the user, whereas the precious metal owned by the user is stored at a deposit site in the possession of the service provider and the computer system will utilise a transaction server and a server for precious metal calculation, whereas the method is compatible with existing banking system and presumes that the user has an existing currency account,

precious metal is purchased on the account backed with precious metal in the bank, in the computer system, a digital valuator for performing info-technological transactions with software support is utilised in order to perform transactions between the currency account and the account backed with precious metal, whereas the digital valuator will:
establish the market price attributed to precious metal at the given moment, whereas the price of precious metal on the account backed with precious metal will be subjected to the fluctuations of the world market price of precious metal,
change the nominal value of the currency account in deposited currency units based on the fluctuations of the world market price of precious metal,
select the target currency for converting precious metal,
based on market price, calculate the exchange rate of national currency in relation to precious metal,
deduct bank fee(s) from the market price attributed to precious metal,
convert all payments both from currency account to the account backed with precious metal and from the account backed with precious metal to the currency account, whereas when a transfer is made to the account backed with precious metal the currency is converted into precious metal and, when transfers are made from the backed account, precious metal is converted into currency,
the value of precious metal on the account backed with precious metal is measured in weight units (oz/g) and interest is also calculated in weight units.

This method is intended to be used within the banking system and, unlike the invention of James Turk, it is presumed that currency-related problems are best solved by utilising a special bank account instead of the payment system. Currency is the best instrument to circulate in a payment system. The positive properties of precious metals can best utilised when kept on a special bank account linked to a relevant payment system.

Also, unlike the invention of James Turk, the precious metal deposited on the account is used based on its intrinsic value, but the instrument circulating in a payment system is currency, not precious metal. Precious metal is purchased by the bank or service provider, and the user does not have to take any particular steps to acquire it or verify its purity. This means low threshold for the user of such account, because the account can be used for depositing even very small amounts of gold and the size of currency payments is not restricted. The holders of such account can use all banking services available for currency account holders.

The purpose of the payment system of the account backed with precious metal is to ensure secure storage and increase of financial assets, and to make payments in different currencies. In order to manage currency-related risk (extensive change of value in exchange rate), the account will be supplemented with a buffer of physical gold. The value of the account is determined by the intrinsic value of physical precious metal. In order to avoid liquidity-related risk (lack of sufficient monetary resources), a payment system is created by the means of the digital valuator. The account is backed if the assets deposited on the account have intrinsic value.

Preferably, the account backed with precious metal is bound to physical precious metal for performing transactions, and it differs from a currency account in that the precious metal deposited on that account can be withdrawn in various currencies at bank offices or ATMs.

Preferably, transactions based on precious metal are performed on equal terms with currencies at bank offices, via online and mobile banking, and using bank cards at ATMs.

Preferably, the account backed with precious metal will be used to deposit currency as physical gold, the value and interest of which are evaluated and calculated in weight units (oz/g), the deposit site is a gold depository, and a special (gold) card is used for accessing the account.

Since the method prescribes that the assets deposited on the account must have intrinsic value, it must be possible to back the account with any asset that has intrinsic value. In the present method the value of assets on the bank account is backed with physical gold or precious metal.

Also preferably, the server for precious metal calculations is the server of gold depository.

Unlike former methods for using gold in the monetary system, a payment system has been created to convert gold into liquid financial asset, which makes it easy to exchange precious metals with goods and services. The method allows using the precious metal on the account on equal terms with currencies and cheques in payment transactions providing precious metal liquidity equivalent to money and cheques.

In comparison with a currency account, it creates an opportunity to increase the profitability of financial assets deposited on the account through increase in intrinsic value of gold. Unlike the currency account, the profitability of a backed account depends mostly on the increase or decrease of the value of gold on the markets, not on the interest rate. During 2001-2012, the price of gold has continually increased on the markets, and—in case of using physical gold on account—it would have increased the value of assets on average by 18% per every ounce (or even 36% in 2006). Price of gold has gone up from 270 USD per ounce in 2001 to 1700 USD per ounce in 2012. In the meantime, the interest rates on currency deposits have, as a rule, remained below annual inflation rate. Due to constant decrease in the value of currency (currencies) (i.e. inflation), it would have been more profitable to deposit physical gold, not currency, on the account. At the same time the value of gold dropped to 1200 USD in 2013 and is rising to 1300 USD per ounce in 2014.

The advantage of using gold (as opposed to other precious metals) in a monetary system is that many countries have already established regulations that exempt it from value added tax if used for financial investment. The Council of the European Union adopted Directive 77/388/EEC of 12 Oct. 1998 on special arrangements applicable to investment gold transactions, which allows the member states to exempt gold from value added tax, if its purity is equal to or greater than 995 thousandths and it is traded on gold accounts.

Using gold to back a bank account means bringing the benefits of a gold standard to the commercial level. By means of payment system, gold is converted to a liquid buffer of the modern monetary system.

The difference of that method does not lie in converting a fixed-rate currency into gold (as in case of gold standard), but in converting the precious metal with intrinsic value and deposited on the account, into currency. In comparison to formerly used gold standards, the process is inverse—gold backing of money vice-versa money backing of gold. The exchange rate of gold is not fixed in relation to any currency. It derives from the demand and supply on the markets, and gold with freely established price is secured by its intrinsic value. The currency deposited as a physical precious metal on the gold account is as valuable as physical gold (as good as gold).

### LIST OF ILLUSTRATIONS

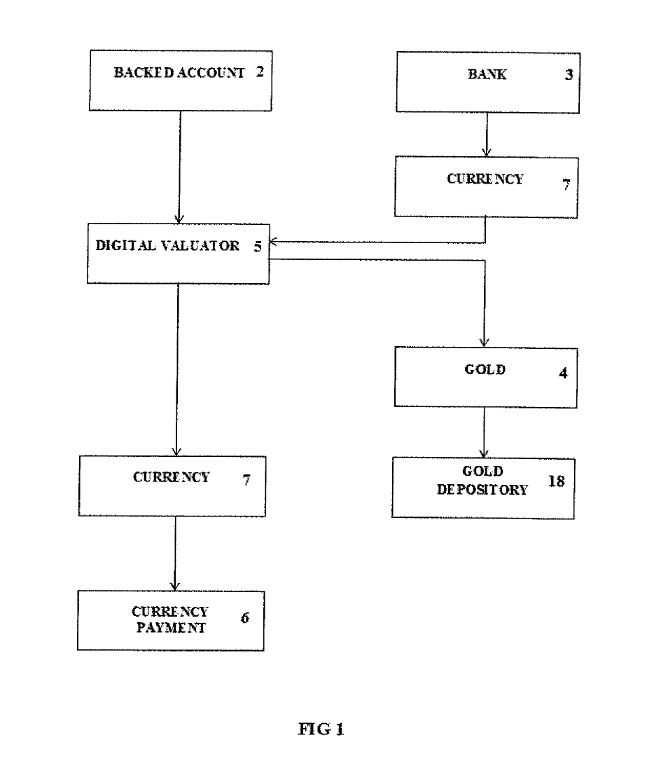

FIG. 1 is a block diagram that illustrates making payments from backed account.

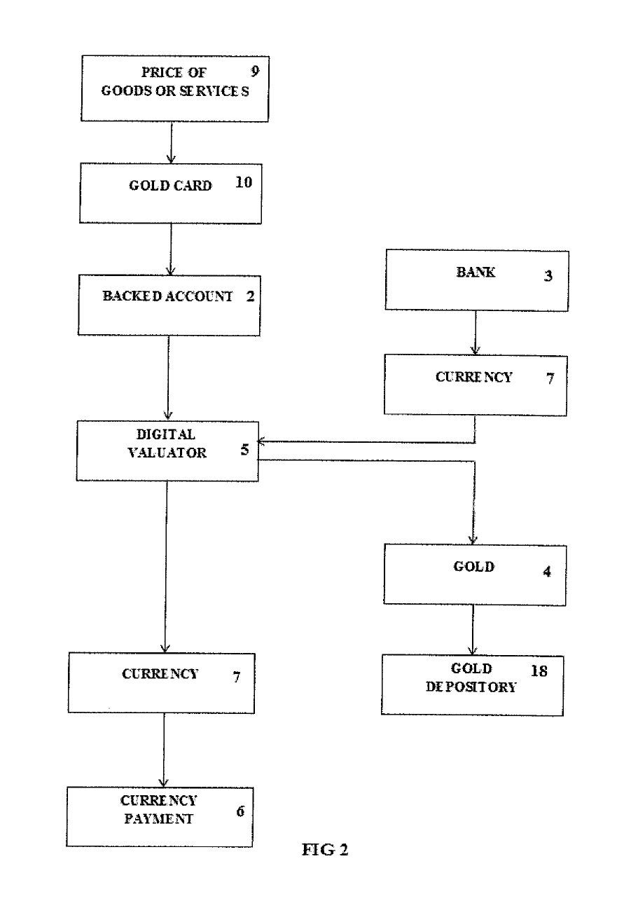

FIG. 2 is a block diagram that illustrates making payments with gold card.

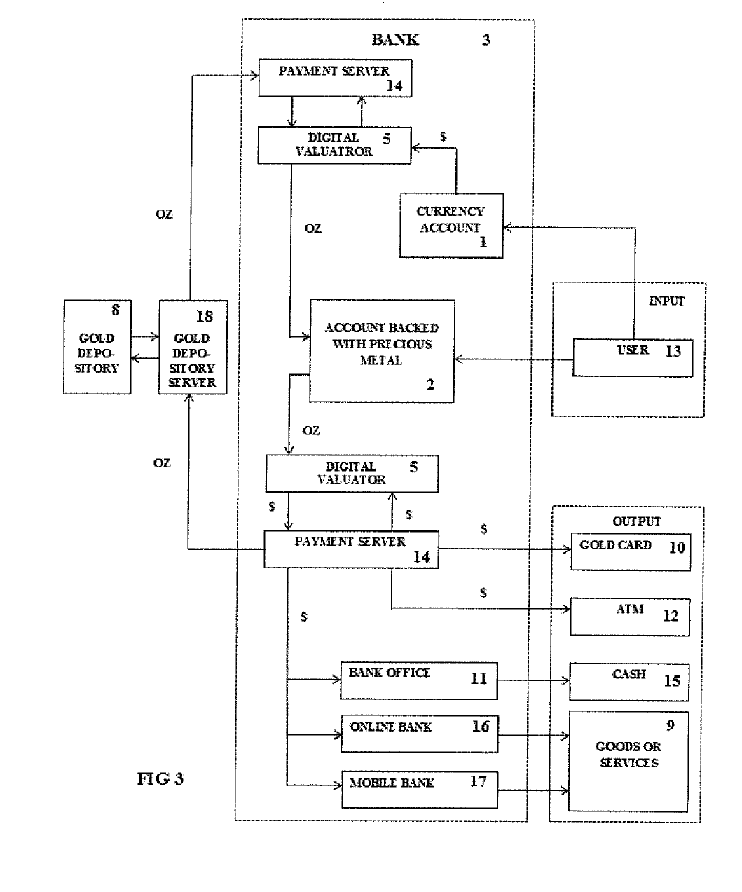

FIG. 3 is a block diagram that illustrates transactions made by the account holder.

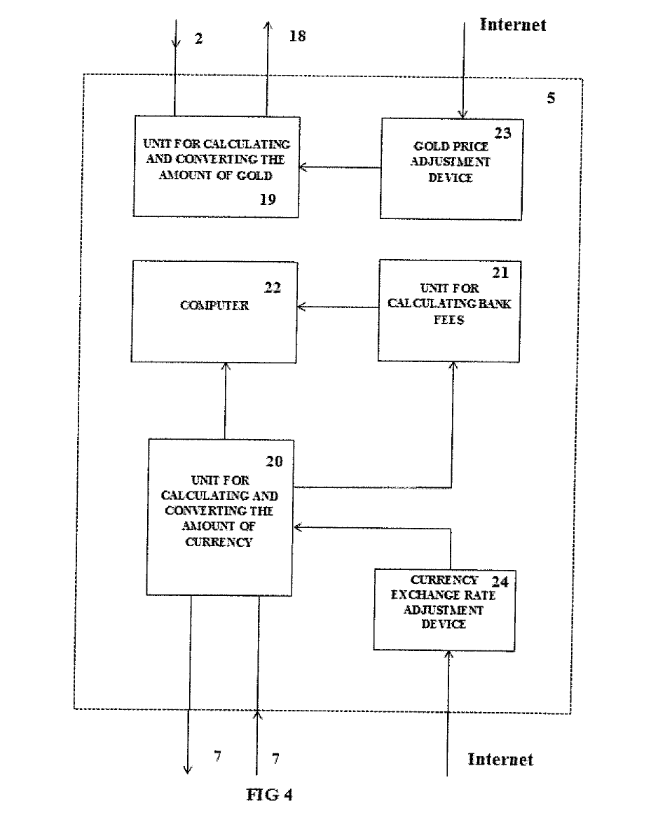

FIG. 4 is a block diagram of digital valuator.

### EXAMPLE OF USING THE METHOD

### Opening an Account Backed with Precious Metal and Purchasing Gold (Precious Metal) for the Account

In the banking system, the account backed with precious metal (hereinafter ‘backed account’) is considered on equal terms with currency account 1. The backed account 2 is opened in bank 3 for depositing currency in physical gold and performing transactions. Prerequisite for opening an account for depositing gold 4 is the presence of currency account(s) in bank. A separate account is created for depositing physical gold (precious metal) on bank account, i.e. an account backed with precious metal.

Bank 3 purchases gold 4 for the backed account 2, based on the market price of gold at the moment of purchase. Gold for backed account is purchased by using currency account 1. At the moment of transferring it to the account, currency is converted into gold in the digital valuator, based on market price of gold (e.g. London Gold Market Fixing Ltd). Conversion in the digital valuator takes place immediately at the moment of initiating the transaction. Purchasing gold for backed account involves the following steps in the following order:
open currency account 1 at the bank (unless it has already been opened earlier);
open backed account 2 at the bank;
purchase desired amount of gold 4 from the bank 3 by using currency account;
convert currency into gold 4 in digital valuator 5;
transfer the amount of purchased gold 4 to the backed account 2.

### EXAMPLE

### Fixing the Price of Gold

In London, gold fixing takes place at 10.30 a.m. every business day morning and at 3 p.m. in the afternoon UK time. The price is fixed in US dollars (USD), British pounds (GBP) and euros (EUR). Gold fixing through digital valuator takes into account the exchange rate currently valid in London, or, on holidays, the exchange rate at the time when markets closed. The value of gold is converted into other currencies according these three currencies convertible on London markets.

The purchased amount of gold is deposited on user's backed account. The amount of gold deposited on the account is calculated in weight units—ounces and grams (hereinafter oz/g). The entire risk for a possible reduction in gold value is borne by the user and the entire revenue from possible increase in gold value belongs to the user, unless the bank shares risk for gold price fluctuations (similar to loan interest within possible fluctuation of gold price, %).

The provided method can be used in a banking system and the gold account can only be used together with currency account(s). Therefore, it is necessary to have currency account(s). The value of gold on a backed account relative to currencies develops as a result of demand and supply on the market. The value of gold (precious metal) on the account with regard to currencies is evaluated when purchasing gold for the account, and reevaluated when using the account for making payments. The currency used for purchasing gold depends on the currency used on currency account(s) and may differ from the currencies used for making payments later on, i.e. when making payments gold can be converted into any currency.

Parallel use of currency account and account backed with precious metal allows making payments between the accounts based on the price of gold (precious metal) established on the market, by selecting the most favourable moment on the market. Timing the transactions to take place when the price of gold or currency is most favourable allows making payment from either the currency account or from the backed account, and as the gold price goes up, increase the financial assets on the currency account, or, as it drops, increase the amount of gold on the account backed with precious metal. Exploiting the ups and downs of gold price on the market allows increasing the respective profitability of accounts (currency account and gold account) within the range accepted by the bank. In the method of backed account method temporal restrictions may, if necessary, be established on large-scale purchase and sales transactions of physical gold.

Purchasing supplementary gold for the gold account or decreasing the amount of gold is implemented (similar to opening the account) through the digital valuator, by using currency account, based on the best possible market price offered on the given day. When using backed account, the account holder chooses between volumes, sums and currencies.

In the backed account method rules are established for making transactions with gold on backed account, based on the following principles:
the bank 3 operating a backed account 2 is required to immediately purchase and sell gold 4 (precious metal) at user's 13 request,
all transactions with physical gold 4 performed on the backed account 2 are carried out in the technical system of the banking environment 3,
in the backed account method sufficient stock of physical gold 4 required for using the backed account 2 is established,
in the backed account method it is prescribed that the backed account 2 is 100% backed with physical gold 4,
the amount of gold 4 on backed account 2 is stored, in its physical form, in the gold depository, depository, central bank, etc.,
gold 4 exchange rate in relation to currencies is not fixed, the price in relation to currencies is formed as a result of supply and demand on the market,
account holder cannot withdraw physical gold 4 from bank 3, in order to perform transactions on backed account 2, gold 4 is always converted into currency,
gold 4 is in the possession of the service provider both before purchasing gold 4, during its storage on backed account 2, and after making currency payments 6 and conversion into currency,
backed account 2 is backed with gold to the extent of the amount of gold 4 purchased for account 2.
   Using Account Backed with Precious Metal in the Banking System

After converting gold into currency through digital valuator, the backed account allows providing all services available for a currency account: making currency payments at the bank office, via online banking, mobile banking and by using a card at an ATM. A backed account also allows making payments both to the backed account and the currency account from any bank. The backed account is used for:
depositing currency (for fixed a term) on the bank account in gold or some other precious metal,
making currency payments from the account backed with gold (precious metal),
using a gold card to make currency payments from the backed account and/or to withdraw cash 15 from an ATM.

### Depositing Currency as Physical Gold (Precious Metal)

The method allows depositing currency in bank as physical gold (precious metal) in weight units (oz/g). Unlike the physical gold kept in bank safe deposit box, the physical gold on a backed account is in active use, and its profitability depends on its amount, market fluctuations, deposit duration, and interest rate.

Bank or service provider guarantees preservation of physical gold and the extent of risk for the account holders mainly depends on the price fluctuations of the precious metal on the market. Risks are also associated with potential insolvency of the bank or service provider, if there is no system for providing compensation for deposits.

When using a backed account for depositing currency in gold (precious metal), the bank will calculate positive or negative interest on equal terms with currency account. Interest is calculated as the percentage of the amount of gold on the account in weight units, i.e. amount of calculated interest is indicated in either ounces or grams. Interest is calculated from the amount of precious metal on the gold account in weight units.

### EXAMPLE

### Calculation of Interest

There are 70 ounces of gold on the gold account, with an annual interest of 1.95%. In a year, 1.365 ounces will be added to the gold on the account. After payment of interest, the account has 71,365 ounces of gold.

Making Currency Payments from and to the Account Backed with Precious Metal

Making payments from the backed account requires the same requisite information and operations as when making payments from a currency account. In order to make payments from the backed account, the user (in addition to all requisite information used in case of currency account) has to choose the target currency for gold conversion. Gold can be converted into currencies determined by the bank or service provider. By the means of the digital valuator necessary amount of gold (precious metal) is converted into chosen currency. The necessary amount of gold depends on the amount of currency required for making the payment and the value of weight unit that serves as the basis for calculation at the moment of use. The final exchange rate in relation to chosen currency will form after computing the market price of gold and bank fees through digital valuator. Making payments from the backed account takes place pursuant to the procedure and in the order described below (FIG. 1):
entering required requisite information,
choosing currency 7 and determining the amount of currency,
converting the amount of gold 4 required for currency payment 6 into currency through digital valuator 5,
make currency payment 6 and transfer the amount of gold 4 used for conversion to gold depository 8.

### EXAMPLE

### Making Currency Payment in Gold (Precious Metal)

Backed account is used for making a payment in the amount of 150 euros. At the moment of making the payment, the market price of gold is 1,600 euros per ounce. In order to make the payment in the amount of 150 euros, gold in the value of 150 euros, as well as bank fees will be deducted from the backed account, which are transferred to the bank. At the same time, 150 euros are transferred to the account indicated by the user. Bank fees can be calculated both in currency and in gold.

All payments to the backed account from other bank and/or currency account are made in currency and have to go through the digital valuator 5 before arriving on the backed account. Through digital valuator 5, the transferred currency is converted into precious metal (gold). When making transfer from the backed account to another backed account, the gold is converted into currency for the moment of making the transfer and back into gold (precious metal) when transferring it to the other backed account.

All payments are made through digital valuator 5, by using currency 7 in the value attributed to gold 4 at the moment of payment. Such transfer does not involve delivery of physical gold 4 to the account of the other party involved in the transaction and/or from one bank to another. Transfer from an account to another account only involves currency 7. Only currency 7 is also used in case of internal bank payments from one account to another. The bank 3 deducts the amount of gold 4 used for payment from the backed account 2 and it will remain in gold depository 8. The amount of gold 4 calculated for the currency payment 6 is deducted from the backed account 2 in weight units (oz/g).

### Payments Through Digital Valuator by Using Bank Card

A special bank card—gold card 10—is issued for the backed account. Gold card 10 issued for withdrawing currency from (gold) account 2 and for paying for goods and services.

All transactions made with gold card 10 are performed in currency 7 through digital valuator 5. Converting gold 4 into currency 7 is performed to the extent that covers payment for goods or services 9. The amount deducted from gold account 2 in weight units (oz/g) depends on the cost of gold traded on the exchange on given trading day. Conversion from gold into currency is based on the currency 7 required for payment for goods or services 9 (EUR, USD, GBP etc.) and market price of gold 4 at the moment of transaction. The amount of gold 4 converted into currency 7 depends on the amount of currency 7 required in exchange for goods or services 9. The transactions will be carried out in the following order (FIG. 2):
cost of goods or services 9 is fixed in currency 7,
gold 4 is converted through digital valuator 5, to the extent that covers the cost of goods or services 9,
payment is made immediately after it is accepted (OK).
gold used for conversion is virtually transferred to gold depository 8.

### EXAMPLE

### Making a Payment with Gold Card 10

Gold card 10 is inserted in the reader. The card 10 is intended to purchase goods, the price of which in the store is 8 euros. Digital valuator 5 converts the required amount of gold into currency 7 (eight euros), based on the trading price of gold 4 (EUR/OZ) at given moment. Upon acceptance (OK), the payment is made to the other party. The amount of gold used for payment is transferred to gold depository 8.

Cash Withdrawal from an Account Backed with a Precious Metal at an Atm Through a Digital Valuator

The payment system of backed account allows withdrawing cash 15 both at the bank office 11 and from ATM 12. Withdrawal of cash 15 from the backed account 2 takes place on equal terms with withdrawal of cash 15 from currency account 1. After inserting gold card 10 in ATM 12 and entering required password, a menu is displayed, indicating available services (incl. withdrawal of cash 15). In addition to the amounts of currency offered, it also shows the exchange rate of gold 4 in relation to given currency 7. When withdrawing cash 15 from the backed account 2 by using gold card 10 and ATM 12, the maximum amount to be withdrawn depends on the limits set by the bank. After selecting the amount of cash 15, the display will indicate the amount of gold necessary for converting it into currency 7. Upon acceptance (OK), the digital valuator 5 will convert gold 4 into currency 7 within the range of selected amount. Deduction from gold account 2 takes place in weight units indicated on the statement of account 2. The amount of gold 4 calculated for transaction (oz/g) will remain in gold depository 8.

### EXAMPLE

### Cash Withdrawal from ATM 12

When inserting the card in ATM 12, the ATM display will show the price of gold in currency 7, that can be withdrawn from this ATM 12. After selecting the amount of currency 7, digital valuator 5 will, based on market price, calculate the amount of gold 4 required for converting into currency 7. The calculated amount of gold 4 is displayed on the screen of ATM After acceptance (OK), the user 13 will receive the currency 7 and the amount of gold 4 used for conversion will be virtually transferred to gold depository 8.

Software support to withdrawing currency at an ATM is provided by the digital valuator in which:
the market price of the precious metal (at the given moment) is established,
the currency used for conversion is selected,
the currency exchange rate in respect of the precious metal is calculated based on the market price,
bank fee(s) are calculated.

FIG. 4 is a block diagram of the digital valuator. The digital valuator 5 contains the unit for calculating and converting the amount of gold 19, unit for calculating and converting the amount of currency 20 and unit for calculating bank fees 21, which are connected to the local computer 22. The digital valuator 5 also contains a gold price adjustment device 23 and currency exchange rate adjustment device 24, inputs of which are connected to Internet.

### LIST OF DESIGNATIONS

1 currency account
2 account backed with precious metal or backed account
3 bank
4 gold
5 digital valuator
6 currency payment
7 currency
8 gold depository
9 goods or services
10 gold card
11 bank office
12 ATM (automatic teller machine)
13 user
14 payment server
15 cash
16 online bank
17 mobile bank
18 server for precious metal calculation, i.e. gold depository server
19 unit for calculating and converting the amount of gold
20 unit for calculating and converting the amount of currency
21 unit for calculating bank fees
22 computer
23 gold price adjustment device
24 currency exchange rate adjustment device

1. A method for calculating and converting the value of currency during financial transactions using an account backed with precious metals, using info-technological means and a computer system in order to convert the precious metal into liquid financial assets, according to which the basis of calculation of financial transactions is established as the weight units of the precious metal acquired by the user, whereas precious metal belonging to the user is stored in deposit site in the possession of the service provider, a computer system utilises a payment server and a server for precious metal calculations, characterized in that
this method is compatible with existing banking system and presumes that the user has an existing currency account,
precious metal is purchased to the account backed with precious metal in bank, in the computer system, a digital valuator is utilised for performing info-technological transactions with software support, in order to perform transactions between currency account and the account backed with precious metal, whereas digital valuator will perform the following:
establish the market price attributed to precious metal at given moment, whereas the price of the precious metal on the account backed with precious metal is subjected to the fluctuations of the price of the precious metal on the world market,
changes the nominal value of the currency account in units of currency deposited on it when the price of the precious metal on the world market fluctuates,
select target currency for converting precious metal,
based on market price, calculate currency exchange rate in relation to precious metal,
calculate bank fee(s) from the market price attributed to precious metal,
convert all payments both from currency account to the account backed with precious metal (2) and from the account hacked with precious metal to currency account.

2. Method according to claim 1, characterized in that the account backed with precious metal is intended for performing transactions backed with physical precious metal and it differs from the currency account in that the precious metal deposited on that account is withdrawn in various currencies only at the bank office or from ATM.

3. Method according to claim 1, characterized in that on equal basis with currencies it is established that transactions with precious metal are carried out at bank offices, online banks, mobile banks and with a bank card at ATMs.

4. Method according to claim 1, characterized in that the precious metal on the account backed with precious metal is gold.

5. Method according to claim 1, characterized in that the established gold deposit site is gold depositor.

6. Method according to claim 1, characterized in that the bank card used for settlement on the account backed with precious metal is an identified gold card intended specifically for that.

7. Method according to claim 1, characterized in that the server for precious metal calculations is the gold depository server.
